(19) United States
(12) Patent Application Publication
(10) Pub. No.: US 2016/0221090 A1
(43) Pub. Date: Aug. 4, 2016

(54) Hand Powered Precision Cutting Device

(71) Applicant: Jacob A. Schmucker, Grabill, IN (US)

(72) Inventor: Jacob A. Schmucker, Grabill, IN (US)

(21) Appl. No.: 14/871,246

(22) Filed: Sep. 30, 2015

(51) Int. Cl. B23D 29/02

(52) U.S. Cl. CPC B23D 29/026

(57) ABSTRACT

A hand powered precision cutting device consisting of a narrow body means having a handle means to allow the device to be held in a person's hand; consisting of a guide means to allow the material to be cut to pass through smoothly through the body means and a cutting means such as a wheel to cut the material along the guide means. A person pulls or pushes the cutting device through the material cutting it in a precise manner.

### CROSS REFERENCE TO RELATED APPLICATIONS

A preliminary on line search of tools for cutting and tools for cutting siding indicated that there were no patents in this field.

The only devices that seemed similar to the present invention were A Rockwell Zip Snip Cordless Cutter and the Rockwell Snip Heavy Duty Rotary Cordless Cutter that are battery operated and seemed primarily designed for box cutting and not for other materials such as metals, including siding for homes.

The applicant has filed a Provisional Patent Application for this invention dated Sep. 30, 2014, Application No. 62/057,363, Atty. Docket Number Roel 9302014.

### BACKGROUND OF THE INVENTION

Working on installing siding on homes, including but not limited to: aluminum; vinyl or other types of siding, there was a need for a hand powered precision cutting device to make precision cuts while installing the siding. In some locations electrical power is either limited or some distance from the working area. Power cutting devices and the electrical cords associated their width are inconvenient and cumbersome to work with. They also can be a safety issue when working at various heights

In addition, the cordless devices such as the Zip Snip cannot cut metal effectively and create safety issues from being cut by the siding being cut. It is more of a push device that the pull aspect of this device disclosed in the present invention is a much better application for cutting various materials other than paper or cardboard.

In many instances today the workers installing siding utilize a utility knife for cutting siding with is a safety issue in that the worker can accidently cut himself while using the utility knife.

### BRIEF SUMMARY OF THE INVENTION

The present invention is unique and simple device that consists of five elements. The invention has a main body means with a handle means to which comprises a cutting edge means which guides the material against the cutting edge means, a cutting means which cuts the material against the cutting edge means and a narrow throat means which allows the material to pass the cutting edge means as the material passing through the device is cut by the wheel means such as a wheel or disk tune of blade.

The material is cut by moving the device through the metal or material to be cut. Depending on the angle and size of the throat means of the invention and metallurgical components and size of the cutting means, different types of metals can be cut as the device is pulled or pushed through the metal being cut.

### BRIEF DESCRIPTION OF SEVERAL VIEWS OF THE INVENTION

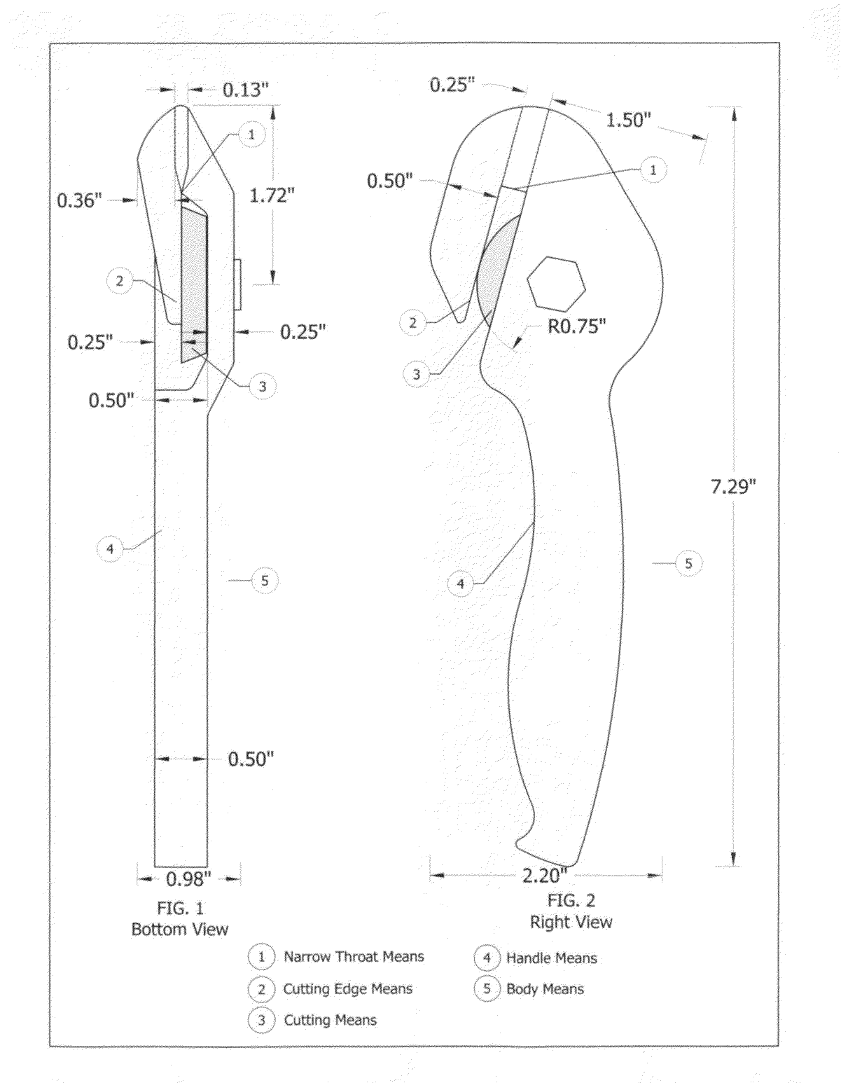

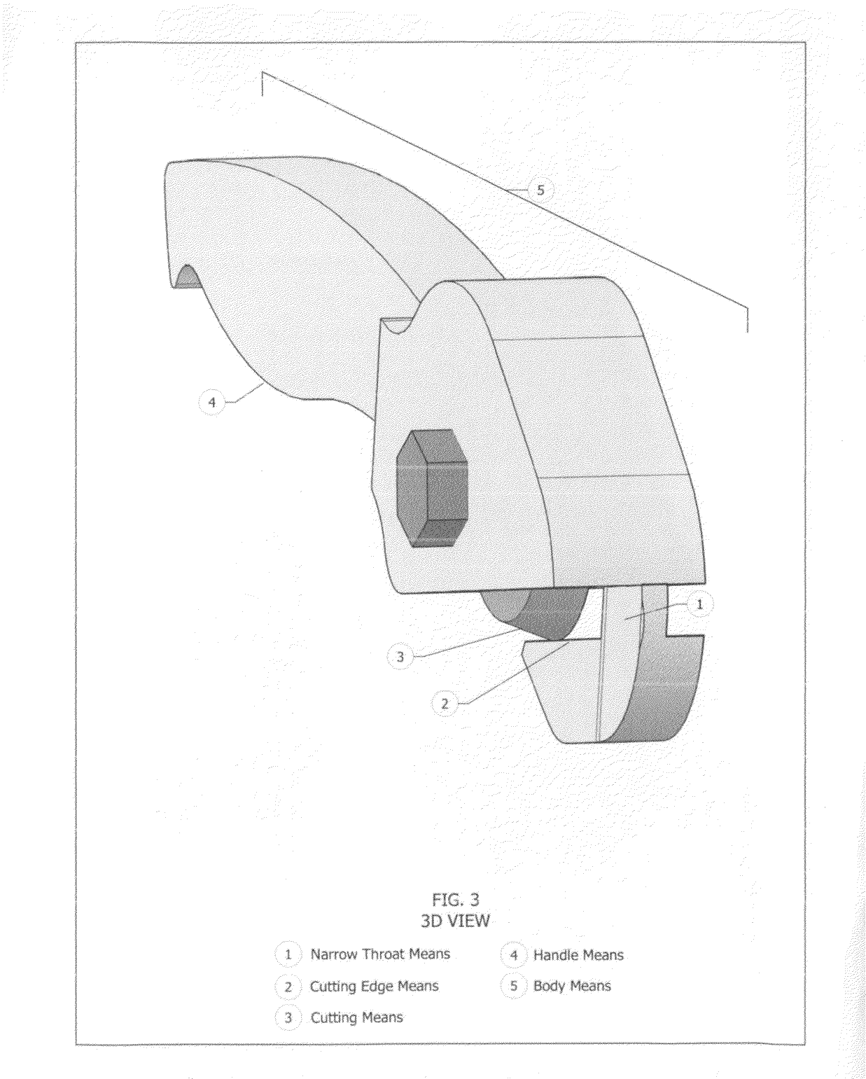

The cutting device is depicted on Page 1 with FIG. 1 being a bottom view of the device and FIG. 2 being a right side view of the device. Page 2 is a three dimensional view, FIG. 3, of cutting device.

The bottom view shows the cutting device consisting of a body means 5 with a handle means 4 where the material to be cut (not shown) passes along the cutting edge means 2 and through the narrow throat means 1 as it is cut by the cutting means 3 as it is pulled through the cutting device.

FIG. 2 is a right side view of the cutting device with a body means 5 consisting of a handle means 4 to pull the cutting device through the metal or siding (not shown) where the metal or siding passes above the cutting edge means 2 and through the narrow throat means 1 which is also part of the body means 5 and is cut by the cutting means 3.

FIG. 3 is a three dimensional view of the invention showing the cutting device with a body means 5 having a handle means 4 to pull the cutting device over the material to be cut (not shown) where the metal siding to be cut passes over the cutting edge means 2 and through the narrow throat means 1 where it is cut by the cutting means 3.

1: A hand powered device used for cutting metals or other materials in a precise manner by either pushing of pulling the precision cutting device through the material consisting of a body means, a handle means, a cutting edge means, a narrow throat means, and a replaceable cutting means.

1: The Precision cutting device described in Independent claim 1 where the precision cutting device is pulled through some type of metal or other material.

2: The Precision cutting device described in Independent claim 1 where the precision cutting device is pulled through siding to be attached to a structure.
